(19) United States
(12) Patent Application Publication
(10) Pub. No.: US 2025/0279436 A1
(43) Pub. Date: Sep. 4, 2025

(54) ELECTRODE AND BATTERY

(71) Applicants: Panasonic Holdings Corporation, Osaka (JP); TOYOTA JIDOSHA KABUSHIKI KAISHA, Aichi (JP)

(72) Inventors: Tatsuya OSHIMA, Osaka (JP); Kouji NISHIDA, Osaka (JP); Nobuhiro TSUJI, Shiga (JP); Manabu MURATA, Shiga (JP); Hisashi KAWAKAMI, Shiga (JP); Yasuo ISHII, Shiga (JP); Masahiro IWASAKI, Toyota-shi (JP)

(21) Appl. No.: 19/209,458

(22) Filed: May 15, 2025

Related U.S. Application Data
(63) Continuation of application No. PCT/JP2023/032150, filed on Sep. 1, 2023.

(30) Foreign Application Priority Data
Nov. 24, 2022 (JP) 2022-187743

(51) Int. Cl. H01M 4/66; H01M 4/36; H01M 4/62; H01M 10/0562

(52) U.S. Cl. CPC H01M 4/667; H01M 4/366; H01M 4/622; H01M 4/661; H01M 4/663; H01M 10/0562; H01M 2300/0068

(57) ABSTRACT

An electrode plate according to the present disclosure includes: a current collector, the current collector including a substrate and a coating layer coating the substrate; and an electrode layer disposed on the current collector, wherein the coating layer includes conductive carbon and a first binder, the electrode layer includes a second binder, the first binder includes an aromatic super engineering plastic, and the second binder includes a styrenic elastomer in which a mole fraction of a repeating unit derived from styrene is 0.18 or more.

This application is a continuation of PCT/JP2023/032150 filed on Sep. 1, 2023, which claims foreign priority of Japanese Patent Application No. 2022-187743 filed on Nov. 24, 2022, the entire contents of both of which are incorporated herein by reference.

### BACKGROUND OF THE INVENTION

### 1. Field of the Invention The present disclosure relates to an electrode and a battery.

### 2. Description of Related Art

A current collector is an essential component of electrochemical devices such as batteries and capacitors. An electrode layer, such as an active material layer, is disposed on the current collector. The adhesion between the current collector and the electrode layer affects the performance of electrochemical devices. A current collector that includes a substrate and a coating layer is known as a current collector capable of enhancing adhesion.

JP 2010-153224 A discloses an electrode that includes a current collector including a coating layer containing a polyimide and an electrode layer provided on the surface of the current collector. The electrode layer contains a styrene-butadiene rubber (SBR).

### SUMMARY OF THE INVENTION

The present disclosure aims to provide an electrode suitable for enhancing the peel strength between the electrode layer and the current collector.

The present disclosure provides an electrode including:

a current collector, the current collector including a substrate and a coating layer coating the substrate; and

an electrode layer disposed on the current collector, wherein

the coating layer includes conductive carbon and a first binder, the

electrode layer includes a second binder,

the first binder includes an aromatic super engineering plastic, and

the second binder includes a styrenic elastomer in which a mole fraction of a repeating unit derived from styrene is 0.18 or more.

According to the present disclosure, it is possible to provide an electrode suitable for enhancing the peel strength between the electrode layer and the current collector.

### BRIEF DESCRIPTION OF THE DRAWINGS

FIG. 1 is a cross-sectional view of an electrode plate according to Embodiment 1.

FIG. 2 is a cross-sectional view of a battery according to Embodiment 2.

FIG. 3 is a cross-sectional view of a battery according to a modification.

### DETAILED DESCRIPTION

Embodiments of the present disclosure are described below with reference to the drawings. The present disclosure is not limited to the following embodiments.

### Embodiment 1

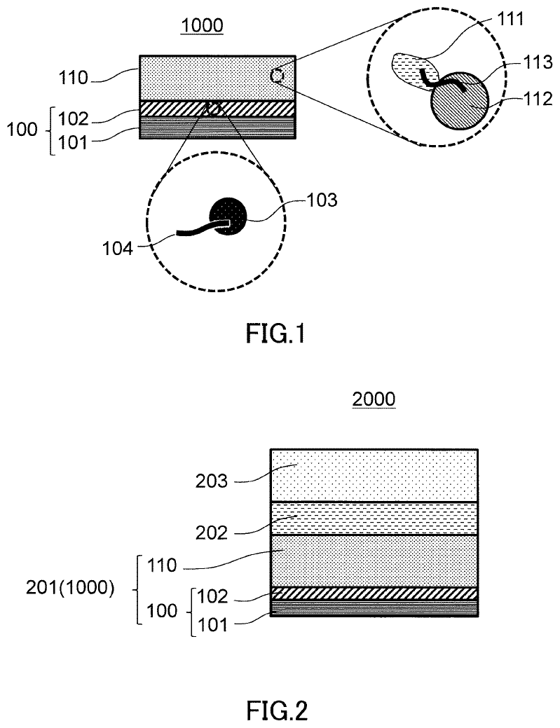

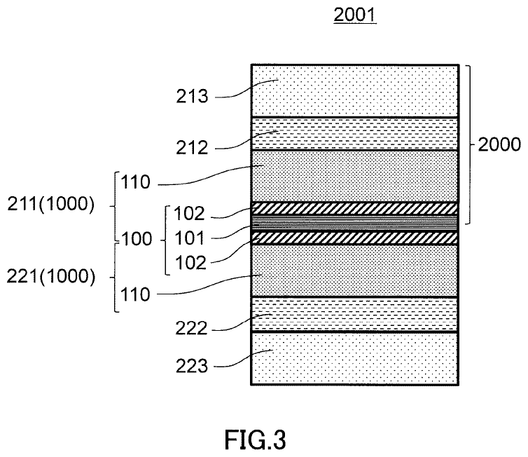

FIG. 1 is a cross-sectional view of an electrode plate 1000 according to Embodiment 1. The electrode plate 1000 includes a current collector 100 and an electrode layer 110. The current collector 100 includes a substrate 101 and a coating layer 102. The coating layer 102 coats the substrate 101 and is in contact with the electrode layer 110. The coating layer 102 includes conductive carbon 103 and a first binder 104. The electrode layer 110 includes a second binder 113. The first binder 104 contains an aromatic super engineering plastic. The second binder 113 contains a styrenic elastomer in which the mole fraction of a repeating unit derived from styrene is 0.18 or more.

According to the above configuration, the peel strength between the electrode layer 110 and the current collector 100 is enhanced. Furthermore, the cycle characteristics of a battery including the electrode plate 1000 can be enhanced. The electrode plate 1000 can be used as an electrode plate for electrochemical devices such as nonaqueous electrolyte batteries, solid-state batteries, and capacitors. The electrode plate 1000 is particularly suitable as an electrode plate for all-solid-state secondary batteries.

Although the reason for the enhancement in peel strength between the electrode layer 110 and the current collector 100 in the electrode plate 1000 is not necessarily definite, it is presumed to be due to the interaction between an aromatic ring contained in the styrenic elastomer (second binder) and an aromatic ring contained in the aromatic super engineering plastic (first binder). An example of this interaction is IT-IT interaction.

According to the electrode plate 1000 of the present embodiment, the electrode layer 110 and the coating layer 102 are in contact with each other. The electrode layer 110 includes the second binder 113 containing the styrenic elastomer in which the mole fraction of the repeating unit derived from styrene is 0.18 or more. The coating layer 102 includes the first binder 104 containing the aromatic super engineering plastic. Accordingly, an interaction is likely to occur between the aromatic ring of the styrenic elastomer contained in the second binder 113 and the aromatic ring contained in the aromatic super engineering plastic contained in the first binder 104.

The electrode layer 110 may include a solid electrolyte 111, an active material 112, or both of these.

### Current Collector

The current collector 100 includes the substrate 101 and the coating layer 102. The coating layer 102 contains the aromatic super engineering plastic. The interaction between the aromatic ring of the aromatic super engineering plastic and the aromatic ring of the styrenic elastomer contained in the electrode layer 110 tends to enhance the peel strength between the electrode layer 110 and the current collector 100.

The current collector 100 has, for example, a plate-like or foil-like shape. The thickness of the current collector 100 may be 0.1 μm or more and 1 mm or less, 1 μm or more and 100 μm or less, or 10 μm or more and 50 μm or less. When the thickness of the current collector 100 is 0.1 μm or more, the strength of the current collector 100 is enhanced, thereby suppressing damage to the current collector 100. When the thickness of the current collector 100 is 1 mm or less, the weight of the current collector 100 is reduced, thereby enabling an enhancement in the energy density of an electrochemical device. That is, by appropriately adjusting the thickness of the current collector 100, it is possible to stably manufacture an electrochemical device and enhance the energy density of an electrochemical device.

### Coating Layer

The coating layer 102 may coat the entire principal surface of the substrate 101 or partially coat the principal surface of the substrate 101. The “principal surface” means the surface of the substrate 101 having the largest area. The coating layer 102 is positioned between the substrate 101 and the electrode layer 110 and is in contact with each of the substrate 101 and the electrode layer 110. The coating layer 102 may have a shape of dots, stripes, or the like.

Examples of the conductive carbon 103 contained in the coating layer 102 include graphite, such as natural graphite and artificial graphite, carbon black, such as acetylene black (AB) and Ketjenblack (KB), conductive fibers, such as carbon fiber (CF), vapor-phase grown carbon (VGCF (registered trademark)), and carbon nanotubes (CNT), and nanocarbons, such as graphene. As the conductive carbon, one conductive carbon selected from these may be used alone, or two or more conductive carbons selected from these may be used.

The first binder 104 included in the coating layer 102 contains an aromatic super engineering plastic. An aromatic super engineering plastic means an engineering plastic that contains an aromatic ring in a main chain backbone and has a continuous use temperature of 150° C. or more. Examples of aromatic super engineering plastics include polybenzimidazole (PBI), polyimide (PI), polyetherketoneetherketoneketone (PEKEKK), polyamide-imide (PAI), polyetheretherketone (PEEK), polyetherketone (PEK), liquid crystal polymer (LCP), polyphenylene sulfide (PPS), polyethersulfone (PES), polyphenylsulfone (PPSU), polyetherimide (PEI), polysulfone (PSU), polyparaphenylene (PPP), and polyarylate (PAR). As the first binder 104, a mixture including two or more selected from these may be used. Aromatic super engineering plastics exhibit high heat resistance. Accordingly, when an aromatic super engineering plastic is included as the first binder 104 in the coating layer 102, the coating layer 102 is less likely to adhere to production equipment, such as a press machine, even under high-temperature compression of a member including the current collector 100. Consequently, the productivity of an electrochemical device is enhanced.

The aromatic super engineering plastic may be a polyimide (PI). Polyimides tend to exhibit higher heat resistance. Accordingly, even under high-temperature compression of a member including the current collector 100, the coating layer 102 is less likely to adhere to production equipment, such as a press machine. Consequently, the productivity of an electrochemical device is enhanced.

The first binder 104 may include an additional binder other than the aromatic super engineering plastic. Alternatively, the first binder 104 may be the aromatic super engineering plastic. In other words, the first binder 104 may contain only the aromatic super engineering plastic.

Examples of the additional binder include polyvinylidene fluoride (PVDF), polytetrafluoroethylene (PTFE), polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester (PMMA), polymethacrylic acid ethyl ester, polymethacrylic acid hexyl ester, polyvinyl acetate, polyvinylpyrrolidone, polyether, polycarbonate, polyethersulfone, polyetherketone, polyetheretherketone, polyphenylene sulfide, hexafluoropolypropylene, styrene-butadiene rubber, carboxymethyl cellulose, and ethyl cellulose. The additional binder can also be a copolymer synthesized using two or more monomers selected from the group consisting of tetrafluoroethylene, hexafluoroethylene, hexafluoropropylene, perfluoroalkyl vinyl ether, vinylidene fluoride, chlorotrifluoroethylene, ethylene, propylene, butadiene, isoprene, styrene, pentafluoropropylene, fluoromethyl vinyl ether, acrylic acid ester, acrylic acid, and hexadiene. As the additional binder, one selected from these may be used alone, or a mixture including two or more selected from these may be used.

The additional binder may contain an elastomer for its excellent binding properties. An elastomer means a polymer with rubber elasticity. The elastomer used as the binder may be a thermoplastic elastomer or a thermosetting elastomer. Examples of the elastomer include, in addition to the styrenic elastomers described above, butadiene rubber (BR), isoprene rubber (IR), chloroprene rubber (CR), acrylonitrile-butadiene rubber (NBR), hydrogenated isoprene rubber (HIR), hydrogenated butyl rubber (HIIR), hydrogenated nitrile rubber (HNBR), and acrylate-butadiene rubber (ABR). A mixture including two or more selected from these may be used.

The content of the first binder 104 in the coating layer 102 is not particularly limited and is, for example, 20 mass % or more and 95 mass % or less, and may be 40 mass % or more and 90 mass % or less, or 55 mass % or more and 85 mass % or less. When the content of the first binder 104 is 95 mass % or less, the electrical conductivity of the coating layer 102 is enhanced, enabling higher output of an electrochemical device. When the content of the first binder 104 is 20 mass % or more, the presence of a sufficient amount of the first binder 104 and the like tend to suppress peeling of the coating layer 102.

The coating layer 102 may include a conductive material other than the conductive carbon 103. Examples of the conductive material other than the conductive carbon include a conductive fiber, such as a metal fiber, fluorinated carbon, a conductive powder, such as aluminum powder, a conductive whisker, such as a zinc oxide whisker or a potassium titanate whisker, a conductive metal oxide, such as titanium oxide, and a conductive polymer, such as polyaniline, polypyrrole, or polythiophene.

The coating layer 102 may contain an element or component other than the conductive carbon 103 and the first binder 104. Such other element or component can be added to the coating layer 102 through contamination or the like. For example, an unavoidable oxide film or the like may be formed on a portion of the surface of the coating layer 102. That is, the coating layer 102 may contain an unavoidable oxide or the like.

The coating layer 102 can be fabricated, for example, by sputtering the material of the coating layer 102 onto the surface of the substrate 101. The coating layer 102 may be fabricated by applying a solution or dispersion including the material of the coating layer 102 to the surface of the substrate 101. The application of the solution or dispersion can be performed using a gravure coater, a die coater, or the like.

The mass per unit area of the coating layer 102 is not particularly limited and may be, for example, 0.01 g/m² or more and 5 g/m² or less, 0.1 g/m² or more and 3 g/m² or less, or 0.5 g/m² or more and 2 g/m² or less. When the mass per unit area is 0.01 g/m² or more, contact between the substrate 101 and the electrode layer can be prevented, thereby suppressing corrosion of the substrate 101. When the mass per unit area is 5 g/m² or less, the electrical resistance of the coating layer 102 decreases, enabling easy high-output operation of an electrochemical device.

The thickness of the coating layer 102 is not particularly limited and may be, for example, 0.001 μm or more and 10 μm or less, 0.01 μm or more and 5 μm or less, or 0.1 μm or more and 3 μm or less. When the thickness of the coating layer 102 is 0.001 μm or more, contact between the substrate 101 and the electrode layer 110 can be prevented, thereby suppressing corrosion of the substrate 101. When the thickness of the coating layer 102 is 10 μm or less, the electrical resistance of the coating layer 102 decreases, enabling easy high-output operation of an electrochemical device.

### Substrate

The substrate 101 has, for example, a plate-like or foil-like shape. The material of the substrate 101 may be a metal or an alloy. Examples of the metal include aluminum, iron, nickel, and copper. Examples of the alloy include aluminum alloys and stainless steel (SUS). The substrate 101 may include aluminum or an aluminum alloy.

The substrate 101 may contain aluminum as a main component. “The substrate 101 contains aluminum as a main component” means that the content of aluminum in the substrate 101 is 50 mass % or more. Aluminum is a lightweight metal with high electrical conductivity. Accordingly, an electrode plate 1000 that includes the substrate 101 containing aluminum as a main component can enhance the gravimetric energy density of an electrochemical device. The substrate 101 containing aluminum as a main component may further contain an element other than aluminum. When the substrate 101 consists of aluminum, that is, when the content of aluminum in the substrate 101 is 100%, the strength of the substrate 101 deteriorates in some cases. Accordingly, the substrate 101 may contain an element other than aluminum. The content of aluminum in the substrate 101 may be 99 mass % or less, or 90 mass % or less.

The substrate 101 may contain an aluminum alloy. Aluminum alloys are lightweight and have high strength. Accordingly, the electrode plate 1000 including the substrate 101 containing an aluminum alloy can achieve an electrochemical device with both high gravimetric energy density and high durability. The aluminum alloy is not particularly limited, examples of which include Al—Cu alloys, Al—Mn alloys, Al—Mn—Cu alloys, and Al—Fe—Cu alloys.

The material of the substrate 101 may be an Al—Mn alloy. Al—Mn alloys have high strength and have excellent formability and corrosion resistance. Accordingly, the electrode plate 1000 including the substrate 101 containing an Al—Mn alloy can enhance the cycle characteristics of a battery.

The thickness of the substrate 101 is not particularly limited and is, for example, 0.1 μm or more and 50 μm or less, and may be 1 μm or more and 30 μm or less. When the thickness of the substrate 101 is 0.1 μm or more, the strength of the substrate 101 is enhanced, thereby suppressing damage to the substrate 101. When the thickness of the substrate 101 is 50 μm or less, the mass of the substrate 101 decreases, enabling an enhancement in the gravimetric energy density of an electrochemical device.

### Electrode Layer

The electrode layer 110 includes the second binder 113. The electrode layer 110 may further include the solid electrolyte 111 and the active material 112. The solid electrolyte 111, the active material 112, and the second binder 113 are described in detail below.

### Solid Electrolyte

The solid electrolyte 111 may include a sulfide solid electrolyte. The sulfide solid electrolyte may contain lithium. By using a sulfide solid electrolyte containing lithium as the solid electrolyte 111, it is possible to manufacture a lithium secondary battery using the electrode plate 1000 including this sulfide solid electrolyte.

The solid electrolyte 111 may include a solid electrolyte other than a sulfide solid electrolyte, such as an oxide solid electrolyte, a halide solid electrolyte, a polymer solid electrolyte, or a complex hydride solid electrolyte. Alternatively, the solid electrolyte 111 may be a sulfide solid electrolyte. In other words, the solid electrolyte 111 may contain only a sulfide solid electrolyte.

In the present disclosure, the “oxide solid electrolyte” means a solid electrolyte that contains oxygen. The oxide solid electrolyte may further contain, as an anion other than oxygen, an anion other than both sulfur and a halogen element.

In the present disclosure, the “halide solid electrolyte” means a solid electrolyte that contains a halogen element and is free of sulfur. In the present disclosure, a sulfur-free solid electrolyte means a solid electrolyte represented by a composition formula that does not contain a sulfur element. Accordingly, a solid electrolyte containing a trace amount of a sulfur component, for example, 0.1 mass % or less of sulfur, is encompassed in sulfur-free solid electrolytes. The halide solid electrolyte may further contain oxygen as an anion other than a halogen element.

The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂. To these, LiX, Li₂O, MO_{q}, LiₚMO_{q}, or the like may be added. The element X in “LiX” is at least one selected from the group consisting of F, Cl, Br, and I. The element M in “MO_{q}” and “LiₚMO_{q}” is at least one selected from the group consisting of P, Si, Ge, B, Al, Ga, In, Fe, and Zn. The symbols p and q in “MO_{q}” and “LiₚMO_{q}” are each independently a natural number.

The sulfide solid electrolyte may be, for example, a Li₂S—P₂S₅-based glass ceramic. To the Li₂S—P₂S₅-based glass ceramic, LiX, Li₂O, MO_{q}, LiₚMO_{q}, or the like may be added, and two or more selected from LiCl, LiBr, and LiI may be added. Li₂S—P₂S₅-based glass ceramics are relatively soft materials, and accordingly the electrode plate 1000 containing a Li₂S—P₂S₅-based glass ceramic enables the manufacture of a more highly durable battery.

The oxide solid electrolyte can be, for example, a NASICON-type solid electrolyte typified by LiTi₂(PO₄)₃ and element-substituted substances thereof, a (LaLi)TiO₃-based perovskite-type solid electrolyte, a LISICON-type solid electrolyte typified by Li₁₄ZnGe₄O₁₆, Li₄SiO₄, and LiGeO₄ and element-substituted substances thereof, a garnet-type solid electrolyte typified by Li₇La₃Zr₂O₁₂ and element-substituted substances thereof, Li₃PO₄ and N-substituted substances thereof, or glass or glass ceramics based on a Li—B—O compound, such as LiBO₂ or LisBO₃, to which Li₂SO₄, Li₂CO₃, or the like is added.

The halide solid electrolyte includes, for example, Li, M1, and X. M1 is at least one selected from the group consisting of metalloid elements and metal elements other than Li. X is at least one selected from the group consisting of F, Cl, Br, and I. Halide solid electrolytes have high thermal stability and accordingly can enhance the safety of a battery. Furthermore, since halide solid electrolytes are free of sulfur, the generation of hydrogen sulfide gas can be suppressed.

In the present disclosure, the “metalloid elements” are B, Si, Ge, As, Sb, and Te.

In the present disclosure, the “metal elements” are all the elements included in Groups 1 to 12 of the periodic table except hydrogen and all the elements included in Groups 13 to 16 of the periodic table except B, Si, Ge, As, Sb, Te, C, N, P, O, S, and Se.

That is, in the present disclosure, the “metalloid elements” and the “metal elements” are each a group of elements that can become a cation when forming an inorganic compound with a halogen element.

For example, the halide solid electrolyte may be a material represented by the following composition formula (1).

Li_{α}M1_{β}X_{γ} Formula (1)

In the above composition formula (1), α, β, and γ are each independently a value greater than 0. The value of γ can be, for example, 4 or 6.

According to the above configuration, the ionic conductivity of the halide solid electrolyte is enhanced. Accordingly, the ionic conductivity of the electrode plate 1000 can be enhanced. This electrode plate 1000, when used in a battery, can further enhance the cycle characteristics of the battery.

In the above composition formula (1), the element M1 may contain Y (=yttrium). That is, the halide solid electrolyte may contain Y as a metal element.

The halide solid electrolyte containing Y may be represented, for example, by the following composition formula (2).

LiₐMe_{b}Y_{c}X₆ Formula (2)

In the formula (2), a, b, and c may satisfy a+mb+3c=6 and c>0. The element Me is at least one selected from the group consisting of metalloid elements and metal elements other than both Li and Y. The value of m represents the valence of the element Me. When the element Me contains a plurality of types of elements, mb represents the sum of the products of the composition ratio of each element multiplied by the valence of the element. For example, when Me contains an element Me1 and an element Me2 where the composition ratio of the element Me1 is b₁, the valence of the element Me1 is m₁, the composition ratio of the element Me2 is b₂, and the valence of the element Me2 is m₂, then mb is expressed as m₁b₁+m₂b₂. In the above composition formula (2), the element X is at least one selected from the group consisting of F, Cl, Br, and I.

The element Me may be, for example, at least one selected from the group consisting of Mg, Ca, Sr, Ba, Zn, Sc, Al, Ga, Bi, Zr, Hf, Ti, Sn, Ta, Gd, and Nb.

The halide solid electrolyte can be, for example, any of the following materials. According to the following materials, the ionic conductivity of the solid electrolyte 111 is further enhanced, enabling a further enhancement in the output characteristics of a battery.

The halide solid electrolyte may be a material represented by the following composition formula (A1).

Li_{6-3d}Y_{d}X₆ Formula (A1)

In the composition formula (A1), the element X is at least one selected from the group consisting of Cl, Br, and I. In the composition formula (A1), d satisfies 0<d<2. The halide solid electrolyte may be a material represented by the following composition formula (A2).

Li₃YX₆ Formula (A2)

In the composition formula (A2), the element X is at least one selected from the group consisting of Cl, Br, and I.

The halide solid electrolyte may be a material represented by the following composition formula (A3).

Li_{3-3δ}Y_{1+δ}Cl₆ Formula (A3)

In the composition formula (A3), 0 satisfies 0<δ≤0.15.

The halide solid electrolyte may be a material represented by the following composition formula (A4).

Li3-38Y1+8Br6 Formula (A4)

In the composition formula (A4), o satisfies 0<δ≤0.25.

The halide solid electrolyte may be a material represented by the following composition formula (A5).

Li_{3-3δ+a}Y_{1+δ-a}MeₐCl_{6-x-y}BrₓI_{y} Formula (A5)

In the composition formula (A5), the element Me is at least one selected from the group consisting of Mg, Ca, Sr, Ba, and Zn.

Furthermore, in the above composition formula (A5), the following are satisfied:

$$- 1 < δ < 2 ,$$

$$0 < a < 3 ,$$

$$0 < ( 3 - 3 δ + a ) ,$$

$$0 < ( 1 + δ - a ) ,$$

$$0 \leq x \leq 6 ,$$

$$0 \leq y \leq 6 , and$$

$$( x + y ) \leq 6 .$$

The halide solid electrolyte may be a material represented by the following composition formula (A6).

Li_{3-3δ}Y_{1+δ-a}MeaCl_{6-x-y}BrₓI_{y} Formula (A6)

In the composition formula (A6), the element Me is at least one selected from the group consisting of Al, Sc, Ga, and Bi.

Furthermore, in the above composition formula (A6), the following are satisfied:

$$- 1 < δ < 1 ,$$

$$0 < a < 2 ,$$

$$0 < ( 1 + δ - a ) ,$$

$$0 \leq x \leq 6 ,$$

$$0 \leq y \leq 6 , and$$

$$( x + y ) \leq 6 .$$

The halide solid electrolyte may be a material represented by the following composition formula (A7).

Li₃₋₃₀₋ₐY_{1+δ-a}MeaCl_{6-x-y}BrₓI_{y} Formula (A7)

In the above composition formula (A7), the element Me is at least one selected from the group consisting of Zr, Hf, and Ti.

Furthermore, in the above composition formula (A7), the following are satisfied:

$$- 1 < δ < 1 ,$$

$$0 < a < 1.5 ,$$

$$0 < ( 3 - 3 δ - a ) ,$$

$$0 < ( 1 + δ - a ) ,$$

$$0 \leq x \leq 6 ,$$

$$0 \leq y \leq 6 , and$$

$$( x + y ) \leq 6 .$$

The halide solid electrolyte may be a material represented by the following composition formula (A8).

Li_{3-3δ-2a}Y_{1+δ-a}MeₐCl_{6-x-y}BrₓI_{y} Formula (A8)

In the composition formula (A8), the element Me is at least one selected from the group consisting of Ta and Nb.

Furthermore, in the above composition formula (A8), the following are satisified:

$$- 1 < δ < 1 ,$$

$$0 < a < 1.2 ,$$

$$0 < ( 3 - 3 δ - 2 a ) ,$$

$$0 < ( 1 + δ - a ) ,$$

$$0 \leq x \leq 6 ,$$

$$0 \leq y \leq 6 , and$$

$$( x + y ) \leq 6 .$$

The halide solid electrolyte may be a compound containing Li, M2, O (oxygen), and X2. The element M2 contains, for example, at least one selected from the group consisting of Nb and Ta. Moreover, X2 is at least one selected from the group consisting of F, Cl, Br, and I.

The compound containing Li, M2, X2, and O (oxygen) may be represented, for example, by he composition formula: LiₓM2O_{y}X2_{5+x-2y}, where x may satisfy 0.1<x<7.0, and y may satisfy 0.4<y<1.9.

The halide solid electrolyte, can be, more specifically, for example, Li₃Y(Cl, Br, I)₆, Li_{2.7}Y_{1.1}(Cl, Br, I)₆, Li ₂Mg(F, Cl, Br, I)₄, Li₂Fe(F, Cl, Br, I)₄, Li(Al, Ga, In)(F, Cl, Br, I)₄, Li₃(Al, Ga, In)(F, Cl, Br, I)₆, Li₃(Ca, Y, Gd)(Cl, Br, I)₆, Li_{2.7}(Ti, Al)F₆, Li_{2.5}(Ti, Al)F₆, or Li(Ta, Nb)O(F, Cl)₄. In the present disclosure, when an element in a formula is expressed as, for example, “(Al, Ga, In)”, this expression indicates at least one element selected from the group of elements in parentheses. That is, “(Al, Ga, In)” is synonymous with “at least one selected from the group consisting of Al, Ga, and In”. The same applies to other elements.

The polymer solid electrolyte can be, for example, a compound of a polymer compound and a lithium salt. The polymer compound may have an ethylene oxide structure. The polymer compound having an ethylene oxide structure can contain a large amount of a lithium salt. Accordingly, the ionic conductivity can be further enhanced. The lithium salt can be LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, or the like. The lithium salts may be used alone or in combination of two or more thereof.

The complex hydride solid electrolyte can be, for example, LiBH₄—LiI or LiBH₄—P₂S₅.

The shape of the solid electrolyte 111 is not particularly limited and may be acicular, spherical, ellipsoidal, or the like. The shape of the solid electrolyte 111 may be particulate.

When the shape of the solid electrolyte 111 is particulate (e.g., spherical), the median diameter of the solid electrolyte 111 may be 0.1 μm or more and 5 μm or less, or 0.5 μm or more and 3 μm or less. When the median diameter of the solid electrolyte 111 is 0.1 μm or more, the dispersibility of the electrode composition (slurry) used for manufacturing the electrode plate 1000 is enhanced and thus the electrode plate 1000 can have a denser structure. When the median diameter of the solid electrolyte 111 is 5 μm or less, the electrode plate 1000 has high surface smoothness and thus can have a denser structure.

The median diameter means the particle diameter at a cumulative volume equal to 50% in the volumetric particle size distribution. The volumetric particle size distribution is determined by laser diffraction scattering. The same applies to other materials below.

The specific surface area of the solid electrolyte 111 may be 0.1 m²/g or more and 100 m²/g or less, or 1 m²/g or more and 10 m²/g or less. When the specific surface area of the solid electrolyte 111 is 0.1 m²/g or more and 100 m²/g or less, the dispersibility of the electrode composition (slurry) used for manufacturing the electrode plate 1000 is enhanced and thus the electrode plate 1000 can have a denser structure. The specific surface area can be measured by the multipoint BET method using a gas adsorption analyzer.

The ionic conductivity of the solid electrolyte 111 may be 0.01 mS/cm² or more, 0.1 mS/cm² or more, or 1 mS/cm² or more. When the ionic conductivity of the solid electrolyte 111 is 0.01 mS/cm² or more, the output characteristics of a battery can be enhanced.

### Active Material

The active material 112 includes a material having properties of occluding and releasing metal ions (e.g., lithium ions). The active material 112 includes, for example, a positive electrode active material or a negative electrode active material. When the electrode plate 1000 includes the active material 112, a lithium secondary battery can be manufactured using the electrode plate 1000.

The active material 112 includes, for example, as a positive electrode active material, a material having properties of occluding and releasing metal ions (e.g., lithium ions). Examples of the positive electrode active material include a transition metal oxide, a transition metal fluoride, a polyanion material, a fluorinated polyanion material, a transition metal sulfide, a transition metal oxysulfide, a transition metal oxynitride, and a lithium-containing compound thereof. Examples of lithium-containing transition metal oxides include Li(NiCoAl)O₂, Li(NiCoMn)O₂, and LiCoO₂. When a lithium-containing transition metal oxide is used as the positive electrode active material, for example, the manufacturing cost of the electrode plate 1000 can be reduced and the average discharge voltage of a battery can be enhanced. Li(NiCoAl)O₂ means that Ni, Co, and Al are contained in any ratio. Li(NiCoMn)O₂ means that Ni, Co, and Mn are contained in any ratio.

The median diameter of the positive electrode active material may be 0.1 μm or more and 100 μm or less, or 1 μm or more and 10 μm or less. When the median diameter of the positive electrode active material is 0.1 μm or more, the active material 112 and the solid electrolyte 111 can be well dispersed in the electrode plate 1000. Accordingly, the charge and discharge characteristics of a battery are enhanced. When the median diameter of the positive electrode active material is 100 μm or less, the lithium diffusion rate within the positive electrode active material is enhanced. Accordingly, a battery can operate at high output.

The active material 112 includes, for example, as a negative electrode active material, a material having properties of occluding and releasing metal ions (e.g., lithium ions). Examples of the negative electrode active material include a metal material, a carbon material, an oxide, a nitride, a tin compound, and a silicon compound. The metal material may be a simple substance of metal or an alloy. Examples of the metal material include lithium metal and a lithium alloy. Examples of the carbon material include natural graphite, coke, partially graphitized carbon, carbon fiber, spherical carbon, artificial graphite, and amorphous carbon. The use of silicon (Si), tin (Sn), a silicon compound, a tin compound or the like can enhance the capacity density of a battery. The use of an oxide compound containing titanium (Ti) or niobium (Nb) can enhance the safety of a battery.

The median diameter of the negative electrode active material may be 0.1 μm or more and 100 μm or less, or 1 μm or more and 10 μm or less. When the median diameter of the negative electrode active material is 0.1 μm or more, the active material 112 and the solid electrolyte 111 can be well dispersed in the electrode plate 1000. Accordingly, the charge and discharge characteristics of a battery are enhanced. When the median diameter of the negative electrode active material is 100 μm or less, the lithium diffusion rate within the negative electrode active material is enhanced. Accordingly, a battery can operate at high output.

The positive electrode active material and the negative electrode active material may be coated with a coating material to reduce the interfacial resistance between each active material and the solid electrolyte. That is, a coating layer may be provided on the surfaces of the positive electrode active material and the negative electrode active material. The coating layer is a layer that includes a coating material. The coating material used for the coating layer can be a material with low electronic conductivity. The coating material used for the coating layer can be an oxide material, an oxide solid electrolyte, a halide solid electrolyte, a sulfide solid electrolyte, or the like. The positive electrode active material and the negative electrode active material may be coated with only one coating material selected from the above-described materials. That is, as the coating layer, a coating layer formed of only one coating material selected from the above-described materials may be provided. Alternatively, two or more coating layers may be provided using two or more coating materials selected from the above-described materials.

Examples of oxide materials used as the coating material of the coating layer include SiO₂, Al₂O₃, TiO₂, B₂O₃, Nb₂O₅, WO₃, and ZrO₂.

The oxide solid electrolyte used as the coating material of the coating layer may be any of the previously exemplified oxide solid electrolytes. Examples of such oxide solid electrolytes include Li—Nb—O compounds, such as LiNbO₃, Li—B—O compounds, such as LiBO₂ and LisBO₃, Li—Al—O compounds, such as LiAlO₂, Li—Si—O compounds, such as Li₄SiO₄, Li—S—O compounds, such as Li₂SO₄, Li—Ti—O compounds, such as Li₄Ti₅O₁₂, Li—Zr—O compounds, such as Li₂ZrO₃, Li—Mo—O compounds, such as Li₂MoO₃, Li—V—O compounds, such as LiV₂O₅, and Li—W—O compounds, such as Li₂WO₄, and Li—P—O compounds, such as LiPO₄. Oxide solid electrolytes have high potential stability. Accordingly, using an oxide solid electrolyte as the coating material can further enhance the cycle characteristics of a battery.

The halide solid electrolyte used as the coating material of the coating layer may be any of the previously exemplified halide solid electrolytes. Examples of such halide solid electrolytes include Li—Y—Cl compounds, such as LiYCl₆, Li—Y—Br—Cl compounds, such as LiYBr₂Cl₄, Li—Ta—O—Cl compounds, such as LiTaOCl₄, and Li—Ti—Al—F compounds, such as Li_{2.7}Ti_{0.3}Al_{0.7}F₆. Halide solid electrolytes have high ionic conductivity and high high-potential stability. Accordingly, using a halide solid electrolyte as the coating material can further enhance the cycle characteristics of a battery.

The sulfide solid electrolyte used as the coating material of the coating layer may be any of the previously exemplified sulfide solid electrolytes. Examples of such sulfide solid electrolytes include Li—P—S compounds, such as Li₂S—P₂S₅. Sulfide solid electrolytes have high ionic conductivity and low Young's modulus. Accordingly, using a sulfide solid electrolyte as the coating material can achieve uniform coating, further enhancing the cycle characteristics of a battery.

### Second Binder

As described above, the second binder 113 contains a styrenic elastomer in which the mole fraction of a repeating unit derived from styrene is 0.18. According to such a configuration, a sufficient amount of an aromatic ring is present in the electrode layer 110, causing a stronger interaction between the second binder 113 and the aromatic super engineering plastic contained in the current collector 100. Accordingly, the peel strength between the electrode layer 110 and the current collector 100 tends to be enhanced. A styrenic elastomer means an elastomer containing a repeating unit derived from styrene. A repeating unit means a molecular structure derived from a monomer and may also be referred to as a constitutional unit. Styrenic elastomers have excellent flexibility and elasticity and accordingly are suitable as a binder for the electrode plate 1000.

In the styrenic elastomer, the ratio of the degree of polymerization m of the repeating unit derived from styrene to the degree of polymerization n of a repeating unit derived from a monomer other than styrene is defined as min. In this case, the mole fraction (φ) of the repeating unit derived from styrene in the styrenic elastomer can be calculated by φ=m/(m+n). The mole fraction (φ) of the repeating unit derived from styrene in the styrenic elastomer can be determined, for example, by proton nuclear magnetic resonance (¹H-NMR) measurement.

In the styrenic elastomer, the mole fraction (φ) of the repeating unit derived from styrene is 0.18 or more. This tends to enhance the peel strength between the electrode layer 110 and the current collector 100. The mole fraction (φ) in the styrenic elastomer may be 0.18 or more and 0.355 or less, or 0.18 or more and 0.3 or less. When the mole fraction (φ) in the styrenic elastomer of 0.18 or more, the strength of the electrode layer 110 can be enhanced. When o in the styrenic elastomer is 0.55 or less, the flexibility of the electrode layer 110 can be enhanced.

The content of the repeating unit derived from styrene in the styrenic elastomer may be 30 mass % or more. This tends to enhance the peel strength between the electrode layer 110 and the current collector 100. The content of the repeating unit derived from styrene in the styrenic elastomer may be 30 mass % or more and 70 mass % or less, or 30 mass % or more and 45 mass % or less. The content of the repeating unit derived from styrene in the styrenic elastomer can be calculated using the mole fraction of each repeating unit contained in the styrenic elastomer, which can be determined by the above-described method, and the molecular weight of each repeating unit. Alternatively, a method using an ultraviolet spectrophotometer can be used for the measurement.

The styrenic elastomer may be a block copolymer that includes a first block composed of a repeating unit derived from styrene and a second block composed of a repeating unit derived from a conjugated diene. Examples of the conjugated diene include butadiene and isoprene. The repeating unit derived from the conjugated diene may be hydrogenated. That is, the repeating unit derived from the conjugated diene may or may not have an unsaturated bond such as a carbon-carbon double bond. The block copolymer may have a triblock sequence composed of two first blocks and one second block. The block copolymer may be an ABA-type triblock copolymer. In this triblock copolymer, the A block corresponds to the first block and the B block corresponds to the second block. The first block functions as a hard segment, for example. The second block functions as a soft segment, for example.

Examples of the styrenic elastomer include styrene-ethylene/butylene-styrene block copolymer (SEBS), styrene-ethylene/propylene-styrene block copolymer (SEPS), styrene-ethylene/ethylene/propylene-styrene block copolymer (SEEPS), styrene-butadiene rubber (SBR), styrene-butadiene-styrene block copolymer (SBS), styrene-isoprene-styrene block copolymer (SIS), and hydrogenated styrene-butadiene rubber (HSBR). The second binder 113 may contain, as the styrenic elastomer, an SBR or an SEBS. The second binder 113 may be a mixture including two or more selected from these. Styrenic elastomers have excellent flexibility and elasticity and accordingly are suitable as a binder for the electrode layer 110.

The styrenic elastomer may be a styrenic triblock copolymer. Examples of styrenic triblock copolymers include styrene-ethylene/butylene-styrene block copolymer (SEBS), styrene-ethylene/propylene-styrene block copolymer (SEPS), styrene-ethylene/ethylene/propylene-styrene block copolymer (SEEPS), styrene-butadiene-styrene block copolymer (SBS), and styrene-isoprene-styrene block copolymer (SIS). These styrenic triblock copolymers may be referred to as styrenic thermoplastic elastomers. These styrenic triblock copolymers tend to be flexible and have high strength.

The styrenic elastomer may contain a styrene-ethylene/butylene-styrene block copolymer (SEBS). SEBS has excellent flexibility and elasticity and has excellent filling characteristics during thermal compression, and accordingly is particularly suitable as a binder for the electrode layer 110.

The styrenic elastomer may contain a modifying group. A modifying group means a functional group that chemically modifies all of the repeating units contained in a polymer chain, a portion of the repeating units contained in the polymer chain, or a terminal portion of the polymer chain. The modifying group can be introduced into the polymer chain through a substitution reaction, an addition reaction, or the like. The modifying group contains, for example, an element having relatively high electronegativity, such as O, N, S, F, Cl, Br, or F, or having relatively low electronegativity, such as Si, Sn, or P. The modifying group containing such an element can impart polarity to the polymer. Examples of the modifying group include a carboxylic acid group, an acid anhydride group, an acyl group, a hydroxy group, a sulfo group, a sulfanyl group, a phosphate group, a phosphonate group, an isocyanate group, an epoxy group, a silyl group, an amino group, a nitrile group, and a nitro group. A specific example of acid anhydride groups is a maleic anhydride group. The modifying group may be a functional group that can be introduced through a reaction with a modifying agent derived from any of the following compounds. Examples of the compound of the modifying agent include an epoxy compound, an ether compound, an ester compound, an isocyanate compound, an isothiocyanate compound, an isocyanuric acid derivative, a nitrogen-containing carbonyl compound, a nitrogen-containing vinyl compound, a nitrogen-containing epoxy compound, a mercapto group derivative, a thiocarbonyl compound, a halogenated silicon compound, an epoxidized silicon compound, a vinylated silicon compound, an alkoxy silicon compound, a nitrogen-containing alkoxy silicon compound, a halogenated tin compound, an organotin carboxylate compound, a phosphite ester compound, and a phosphino compound. When the styrenic elastomer in the second binder 113 contains any of the above modifying groups, the interaction with the current collector 100 can enhance the peel strength between the electrode layer 110 and the current collector 100.

The styrenic elastomer may contain a modifying group containing a nitrogen atom. A modifying group containing a nitrogen atom is a nitrogen-containing functional group, examples of which include an amino group such as that in an amine compound. The position of the modifying group may be at a polymer chain terminal. The styrenic elastomer may be, for example, a terminal amine-modified styrenic elastomer. The styrenic elastomer may be, for example, a styrenic elastomer having a nitrogen atom at at least one terminal of a polymer chain and having a star polymer structure centered on a nitrogen-containing alkoxysilane substituent.

The weight-average molecular weight (Mw) of the styrenic elastomer may be 200,000 or more. The weight-average molecular weight of the styrenic elastomer may be 300,000 or more, 500,000 or more, 800,000 or more, or 1,000,000 or more. The upper limit value of the weight-average molecular weight is, for example, 1,500,000.

When the weight-average molecular weight of the styrenic elastomer is 200,000 or more, the particles of the solid electrolyte 111 and the particles of the active material 112 can adhere to each other with sufficient adhesive strength. When the weight-average molecular weight of the styrenic elastomer is 1,500,000 or less, ionic conduction between the particles of the solid electrolyte 111 is less likely to be hindered by the second binder 113, enabling an enhancement in the output characteristics of a battery. The weight-average molecular weight of the styrenic elastomer can be determined, for example, by gel permeation chromatography (GPC) measurement using polystyrene as a standard sample. In other words, the weight-average molecular weight is a value converted to polystyrene equivalent. In the GPC measurement, chloroform may be used as an eluent. When two or more peak tops are observed in the chart obtained by the GPC measurement, the weight-average molecular weight calculated from the entire peak range including the peak tops can be defined as the weight-average molecular weight of the styrenic elastomer.

The second binder 113 may include a binder other than the styrenic elastomer. Alternatively, the second binder 113 may be the styrenic elastomer. In other words, the second binder 113 may include only the styrenic elastomer.

The styrenic elastomer may be an oil-extended polymer containing a process oil or the like to improve processability. Examples of the process oil include an aromatic oil, a paraffinic oil, a naphthenic oil, a vegetable oil, and an oil with a low polycyclic aromatic compound content (low PCA oil). The process oil may be a low PCA oil. Examples of low PCA oils include mild extraction solvate (MES), oils produced by treating aromatic extracts from distillate oils (TDAE), special aromatic extracts from residual oils (SRAE), and heavy naphthenic oils. The ratio of the mass of the process oil to the mass of the styrenic elastomer is not particularly limited and is, for example, 10 mass % or more and 100 mass % or less. When the second binder 113 contains the process oil, the process oil can serve as a lubricant, thereby enhancing the filling characteristics of the electrode layer 110.

The ratio of the mass of the process oil to the mass of the styrenic elastomer may be 1 mass % or less. When the ratio of the mass of the process oil to the mass of the styrenic elastomer is 1 mass % or less, the reaction between the process oil and the solid electrolyte can be suppressed, enhancing the cycle characteristics of a battery. When the styrenic elastomer is an oil-extended polymer, the oil contained in the styrenic elastomer can be removed by dissolving the styrenic elastomer in tetrahydrofuran (THF) followed by washing through reprecipitation in ethanol and reprecipitation in acetone.

### Electrode Layer

The electrode layer 110 includes the second binder 113. The electrode layer 110 may further include the solid electrolyte 111, the active material 112, or both of these. According to this configuration, while sufficient strength of the electrode layer 110 is maintained, the ionic conductivity within the electrode layer 110 is enhanced, enabling high-output operation of a battery.

The median diameter of the solid electrolyte 111 included in the electrode layer 110 may be smaller than the median diameter of the active material 112. Accordingly, the solid electrolyte 111 and the active material 112 can be well dispersed.

In the electrode layer 110, the volume ratio “v1:100−v1” between the active material 112 and the solid electrolyte 111 may satisfy 30≤v1≤95, where v1 represents the volume ratio of the active material 112 when the sum of the volumes of the active material 112 and the solid electrolyte 111 included in the electrode layer 110 is taken as 100. When 30≤v1 is satisfied, sufficient energy density of a battery can be easily ensured. When v1≤95 is satisfied, high-output operation of a battery can be more easily performed.

The thickness of the electrode layer 110 may be 10 μm or more and 500 μm or less. When the thickness of the electrode layer 110 is 10 μm or more, sufficient energy density of a battery can be easily ensured. When the thickness of the electrode layer 110 is 500 μm or less, high-output operation of a battery can be more easily performed.

In the electrode layer 110, the ratio of the second binder 113 to the solid electrolyte 111 may be 0.1 mass % or more and 10 mass % or less, 0.5 mass % or more and 8 mass % or less, or 1 mass % or more and 5 mass % or less. When the ratio of the second binder 113 to the solid electrolyte 111 is 0.1 mass % or more, the second binder 113 tends to bind a greater number of particles of the solid electrolyte 111 together. Accordingly, the film strength of the electrode layer 110 can be enhanced. When the ratio of the second binder 113 to the solid electrolyte 111 is 10 mass % or less, the contact between the particles of the solid electrolyte 111 in the electrode layer 110 tends to be enhanced. Accordingly, the ionic conductivity of the electrode layer 110 can be enhanced.

In the electrode layer 110, the ratio of the second binder 113 to the active material 112 may be 0.03 mass % or more and 4 mass % or less, 0.15 mass % or more and 2 mass % or less, or 0.3 mass % or more and 1 mass % or less. When the ratio of the second binder 113 to the active material 112 is 0.03 mass % or more, the second binder 113 tends to bind a greater number of particles of the active material 112 together. Accordingly, the film strength of the electrode layer 110 can be enhanced. When the ratio of the second binder 113 to the active material 112 is 4 mass % or less, the contact between the particles of the active material 112 in the electrode layer 110 tends to enhance. Accordingly, the output characteristics of a battery can be enhanced.

The electrode layer 110 may further contain a conductive additive for the purpose of enhancing electronic conductivity. Examples of the conductive additive include graphite, such as natural graphite or artificial graphite, carbon black, such as acetylene black or Ketjenblack, a conductive fiber, such as a carbon fiber or a metal fiber, fluorinated carbon, a conductive powder, such as aluminum powder, a conductive whisker, such as a zinc oxide whisker or a potassium titanate whisker, a conductive metal oxide, such as titanium oxide, and a conductive polymer, such as polyaniline, polypyrrole, or polythiophene. The use of carbon materials as the conductive additive can achieve cost reduction.

The electrode layer 110 may contain a dispersant for the purpose of enhancing the dispersibility of the solid electrolyte 111 and the active material 112. The dispersant may be a low-molecular-weight dispersant or a high-molecular-weight dispersant. As the dispersant, a commercially available dispersant, wetting agent, or surfactant may be used, for example.

In the electrode layer 110, the dispersant may contain an amine compound. Amine compounds are suitable for enhancing the dispersibility of the solid electrolyte 111. Examples of the amine compound include an aliphatic amine, such as methylamine or dimethylamine, an aromatic amine, such as aniline, and a heterocyclic amine, such as imidazole or imidazoline.

In the electrode layer 110, the dispersant may contain imidazoline or an imidazoline derivative. Imidazoline or imidazoline derivatives are more suitable for enhancing the dispersibility of the solid electrolyte 111. Examples of the imidazoline derivative include 1-hydroxyethyl-2-alkenylimidazoline.

In the electrode layer 110, the ratio of the mass of the dispersant to the mass of the solid electrolyte 111 is not particularly limited and is, for example, 0.001 mass % or more and 10 mass % or less, and may be 0.01 mass % or more and 1.0 mass % or less. When the ratio of the mass of the dispersant is 0.001 mass % or more, the dispersibility of the solid electrolyte 111 in the electrode layer 110 can be enhanced. When the ratio of the mass of the dispersant is 10 mass % or less, a decrease in the ionic conductivity of the solid electrolyte 111 can be suppressed.

### Manufacturing Method for Electrode Plate

The electrode plate 1000 can be fabricated, for example, by the following method. First, an electrode composition for forming the electrode layer 110 is prepared in which the solid electrolyte 111, the active material 112, and the second binder 113 are included. The electrode composition may be a slurry in which the solid electrolyte 111, the active material 112, and the second binder 113 are dispersed in a solvent. The solvent can be a solvent that does not react with the solid electrolyte 111, for example, an aromatic hydrocarbon solvent, such as tetralin. Subsequently, the electrode composition is applied onto the coating layer 102 of the current collector 100. Examples of methods for applying the electrode composition include die coating, gravure coating, doctor blading, bar coating, spray coating, and electrostatic coating. The resulting coating film is dried and thus the electrode layer 110 is formed, and the electrode plate 1000 can be obtained. The drying method for the coating film is not particularly limited. For example, the coating film may be dried by heating the coating film at a set temperature of 80° C. or more and 150° C. or less using warm air or hot air drying. A method of applying the electrode composition onto the coating layer 102 to fabricate the electrode layer 110 may be referred to as wet coating.

### Measurement Method for Peel Strength of Electrode Plate

The peel strength between the electrode layer 110 and the current collector 100 can be measured in a dry room with a dew point of −50° C. or less, using a universal material testing machine (RTH-1310, manufactured by A&D HOLON Holdings Company, Limited) in the following manner. First, a 15-mm-wide cut piece of the electrode plate 1000 and a test plate are adhered to each other using a double-sided adhesive tape. In detail, the electrode layer 110 of the electrode plate 1000 is bonded to the test plate using via the double-sided adhesive tape. Subsequently, the electrode layer 110 is peeled off from the current collector 100 at a peel angle of 90° and a peel rate of 5 mm/min using the testing machine equipped with a jig for 90° peel tests of adhesive tape. After the measurement started, the measured values for the initial 5 mm to 12 mm length peeled off from the current collector 100 are excluded, and then the measured values (unit: N) recorded continuously for 5 mm length of the electrode layer 110 peeled off from the current collector 100 are obtained. The average value (Av) of the values obtained by dividing each measured value by the width of the electrode plate 1000 can be defined as the peel strength (unit: N/m) between the electrode layer 110 and the current collector 100 of the electrode plate 1000.

### Embodiment 2

FIG. 2 is a cross-sectional view of a battery 2000 according to Embodiment 2. The battery 2000 includes a negative electrode 201, a positive electrode 203, and an electrolyte layer 202.

At least one selected from the group consisting of the negative electrode 201 and the positive electrode 203 includes the electrode plate 1000 according to Embodiment 1. That is, at least one selected from the group consisting of the negative electrode 201 and the positive electrode 203 includes the electrode layer 110 and the current collector 100.

The electrolyte layer 202 is positioned between the negative electrode 201 and the positive electrode 203.

The peel strength between the electrode layer 110 and the current collector 100 is high and accordingly, the battery 2000 using the electrode plate 1000 that includes the electrode layer 110 and the current collector 100 as described above has excellent cycle characteristics. Furthermore, the output characteristics of the battery 2000 can also be enhanced.

As shown in FIG. 2, in the battery 2000, the negative electrode 201 may be the electrode plate 1000 according to Embodiment 1. In this case, the negative electrode 201 includes the electrode layer 110 and the current collector 100 described in Embodiment 1. In the following, the battery 2000 in which the negative electrode 201 is the electrode plate 1000 is described. However, the battery 2000 is not limited to the following embodiment. In the battery 2000, the positive electrode 203 may be the electrode plate 1000 according to Embodiment 1 described above.

According to the above configuration, the output characteristics of the battery 2000 can be further enhanced.

The electrolyte layer 202 is a layer that includes an electrolyte material. Examples of the electrolyte material include a solid electrolyte. That is, the electrolyte layer 202 may be a solid electrolyte layer. The solid electrolyte included in the electrolyte layer 202 may be any of the solid electrolytes exemplified as the solid electrolyte 111 and can be, for example, a sulfide solid electrolyte, an oxide solid electrolyte, a halide solid electrolyte, a polymer solid electrolyte, or a complex hydride solid electrolyte.

The electrolyte layer 202 may contain the solid electrolyte as a main component. The electrolyte layer 202 may contain the solid electrolyte in a mass proportion of 70% or more (70 mass % or more) in the entire electrolyte layer 202.

According to the above configuration, the charge and discharge characteristics of the battery 2000 can be enhanced.

The electrolyte layer 202 may contain the solid electrolyte as a main component and further contain an unavoidable impurity, or a starting material for use in synthesizing the solid electrolyte, a by-product, a decomposition product, or the like.

The electrolyte layer 202 may contain the solid electrolyte in a mass proportion of 100% (100 mass %) in the entire electrolyte layer 202, except for an unavoidably incorporated impurity.

According to the above configuration, the charge and discharge characteristics of the battery 2000 can be further enhanced.

The electrolyte layer 202 may include two or more of the materials exemplified as the solid electrolyte. For example, the electrolyte layer 202 may include a halide solid electrolyte and a sulfide solid electrolyte.

The thickness of the electrolyte layer 202 may be 1 μm or more and 300 μm or less. When the thickness of the electrolyte layer 202 is 1 μm or more, the likelihood of a short circuit between the negative electrode 201 and the positive electrode 203 is reduced. When the thickness of the electrolyte layer 202 is 300 μm or less, high-output operation of the battery 2000 can be easily performed. That is, by appropriately adjusting the thickness of the electrolyte layer 202, the safety of the battery 2000 can be sufficiently ensured and the battery 2000 can be operated at high output.

The shape of the solid electrolyte included in the battery 2000 is not particularly limited. The shape of the solid electrolyte may be acicular, spherical, ellipsoidal, or the like. The shape of the solid electrolyte may be particulate.

The positive electrode 203 may include an electrolyte material and may include, for example, a solid electrolyte. The solid electrolyte can be any of the solid electrolytes exemplified as the material constituting the electrolyte layer 202. According to the above configuration, ionic conductivity (e.g., lithium-ion conductivity) within the positive electrode 203 is enhanced, enabling high-output operation of the battery 2000.

The positive electrode 203 includes, for example, as a positive electrode active material, a material having properties of occluding and releasing metal ions (e.g., lithium ions). The positive electrode active material may be any of the materials exemplified in the above-described Embodiment 1.

The median diameter of the positive electrode active material may be 0.1 μm or more and 100 μm or less. When the median diameter of the positive electrode active material is 0.1 μm or more, the positive electrode active material and the solid electrolyte can be well dispersed in the positive electrode 203. Accordingly, the charge and discharge characteristics of the battery 2000 are enhanced. When the median diameter of the positive electrode active material is 100 μm or less, the lithium diffusion rate within the positive electrode active material is enhanced. Accordingly, the battery 2000 can operate at high output.

The median diameter of the positive electrode active material may be larger than the median diameter of the solid electrolyte. Accordingly, the solid electrolyte and the positive electrode active material can be well dispersed.

In the positive electrode 203, the volume ratio “v2:100−v2” between the positive electrode active material and the solid electrolyte may satisfy 30≤v2≤95, where v2 represents the volume ratio of the positive electrode active material when the sum of the volumes of the positive electrode active material and the solid electrolyte included in the positive electrode 203 is taken as 100. When 30≤v2 is satisfied, sufficient energy density of the battery 2000 can be easily ensured. When v2≤95 is satisfied, high-output operation of the battery 2000 can be more easily performed.

The thickness of the positive electrode 203 may be 10 μm or more and 500 μm or less. When the thickness of the positive electrode 203 is 10 μm or more, sufficient energy density of the battery 2000 can be easily ensured. When the thickness of the positive electrode 203 is 500 μm or less, high-output operation of the battery 2000 can be more easily performed.

The positive electrode active material may be coated with a coating material to reduce the interfacial resistance with the solid electrolyte. The coating material can be a material with low electronic conductivity. The coating material can be an oxide material, an oxide solid electrolyte, or the like. The coating material may be any of the materials exemplified in Embodiment 1.

At least one selected from the group consisting of the electrolyte layer 202 and the positive electrode 203 may contain a binder for the purpose of enhancing adhesion between the particles. The binder can be any of the materials exemplified in Embodiment 1. One binder may be used alone, or two or more binders may be used in combination.

The binder may be an elastomer for its excellent binding properties. An elastomer means a polymer with elasticity. The elastomer used as the binder may be a thermoplastic elastomer or a thermosetting elastomer. The binder may contain a thermoplastic elastomer. The elastomer can be any of the materials exemplified in Embodiment 1. When the binder contains an elastomer, high loading in the electrolyte layer 202 or the positive electrode 203 can be achieved, for example, through thermal compression during the manufacture of the battery 2000.

At least one selected from the group consisting of the electrode layer 110 of the negative electrode 201, the electrolyte layer 202, and the positive electrode 203 may contain a nonaqueous electrolyte solution, a gel electrolyte, or an ionic liquid for the purpose of facilitating the transfer of lithium ions and enhancing the output characteristics of the battery 2000.

The nonaqueous electrolyte solution contains a nonaqueous solvent and a lithium salt dissolved in the nonaqueous solvent. The nonaqueous solvent can be a cyclic carbonate solvent, a chain carbonate solvent, a cyclic ether solvent, a chain ether solvent, a cyclic ester solvent, a chain ester solvent, a fluorinated solvent, or the like. Examples of cyclic carbonate solvents include ethylene carbonate, propylene carbonate, and butylene carbonate. Examples of chain carbonate solvents include dimethyl carbonate, ethyl methyl carbonate, and diethyl carbonate. Examples of cyclic ether solvents include tetrahydrofuran, 1,4-dioxane, and 1,3-dioxolane. Examples of chain ether solvents include 1,2-dimethoxyethane and 1,2-diethoxyethane. Examples of cyclic ester solvents include y-butyrolactone. Examples of chain ester solvents include methyl acetate. Examples of fluorinated solvents include fluoroethylene carbonate, methyl fluoropropionate, fluorobenzene, fluoroethylmethyl carbonate, and fluorodimethylene carbonate. As the nonaqueous solvent, one nonaqueous solvent selected from these may be used alone, or a mixture of two or more nonaqueous solvents selected from these may be used.

The nonaqueous electrolyte solution may contain at least one fluorinated solvent selected from the group consisting of fluoroethylene carbonate, methyl fluoropropionate, fluorobenzene, fluoroethylmethyl carbonate, and fluorodimethylene carbonate.

Examples of the lithium salt include LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), and LiC(SO₂CF₃)₃. As the lithium salt, one lithium salt selected from these may be used alone, or a mixture of two or more lithium salts selected from these may be used. The concentration of the lithium salt in the nonaqueous electrolyte solution may be 0.5 mol/liter or more and 2 mol/liter or less.

The gel electrolyte can be a material obtained by impregnating a polymer material with a nonaqueous electrolyte solution. Examples of the polymer material include polyethylene oxide, polyacrylonitrile, polyvinylidene fluoride, polymethyl methacrylate, and a polymer having an ethylene oxide bond.

A cation constituting the ionic liquid may be an aliphatic chain quaternary cation, such as tetraalkylammonium or tetraalkylphosphonium, an aliphatic cyclic ammonium, such as pyrrolidinium, morpholinium, imidazolinium, tetrahydropyrimidinium, piperazinium, or piperidinium, a nitrogen-containing heterocyclic aromatic cation, such as pyridinium or imidazolium, or the like. An anion constituting the ionic liquid may be PF₆⁻, BF₄⁻, SbF₆⁻, AsF₆⁻, SO₃CF₃⁻, N(SO₂F)₂, N(SO₂CF₃)₂⁻, N(SO₂C₂F₅)₂⁻, N(SO₂CF₃)(SO₂C₄F₉)⁻, C(SO₂CF₃)₃⁻, or the like. The ionic liquid may contain a lithium salt.

At least one selected from the group consisting of the electrode layer 110 of the negative electrode 201 and the positive electrode 203 may contain a conductive additive for the purpose of enhancing electronic conductivity. The conductive additive can be any of the materials exemplified in Embodiment 1.

At least one selected from the group consisting of the electrode layer 110 of the negative electrode 201 and the positive electrode 203 may contain a dispersant for the purpose of enhancing the dispersibility of the solid electrolytes and the active materials. The dispersant can be any of the materials exemplified in Embodiment 1.

Examples of the shape of the battery 2000 include a coin type, a cylindrical type, a prismatic type, a sheet type, a button type, a flat type, and a stacked type.

The battery 2000 can be manufactured, for example, by the following method. First, the current collector 100, materials for forming the electrode layer 110, materials for forming the electrolyte layer 202, materials for forming the positive electrode 203, and a current collector for the positive electrode 203 are each prepared. These are used to fabricate a stack in which the negative electrode 201, the electrolyte layer 202, and the positive electrode 203 are disposed in this order, by a known method. Thus, the battery 2000 can be manufactured.

FIG. 4 is a cross-sectional view of a battery 2001 according to a modification. The battery 2001 can be a stack of a plurality of the batteries 2000. The battery 2001 may be manufactured by the following method. A negative electrode (first negative electrode 211) in which the electrode layer 110 is stacked on the current collector 100 including the substrate 101 with the coating layer 102 disposed on both surfaces thereof, a first electrolyte layer 212, and a first positive electrode 213 are disposed in this order. On the other hand, on the opposite surface of the current collector 100 to the surface on which the first negative electrode 211 is stacked, the electrode layer 110 (second negative electrode 221), a second electrolyte layer 222, and a second positive electrode 223 are disposed in this order. Thus, a stack is obtained in which the first positive electrode 213, the first electrolyte layer 212, the first negative electrode 211, the current collector 100, the second negative electrode 221, the second electrolyte layer 222, and the second positive electrode 223 are disposed in this order. This stack may be pressure-formed at a high temperature, for example, at a temperature of 120° C. or more and 195° C. or less, using a press machine to manufacture the battery 2001. According to such a method, it is possible to fabricate a stack of two batteries 2000 while suppressing battery warpage, enabling more efficient manufacturing of the high-output battery 2001. In fabricating the battery 2001, the order of stacking the members is not particularly limited. For example, after the first negative electrode 211 and the second negative electrode 221 are disposed on the current collector 100, the first electrolyte layer 212, the second electrolyte layer 222, the first positive electrode 213, and the second positive electrode 223 may be stacked in this order to fabricate a stack of two batteries 2000. Furthermore, a plurality of the batteries 2001 and a plurality of positive electrode current collectors may be prepared and the battery 2001 and the positive electrode current collector may be alternately stacked to manufacture a stack of the battery 2000. Such a method enables the battery 2000 to be stacked with high efficiency.

### Other Embodiments

### Supplementary Description

The above description of the embodiments discloses the following techniques.

### Technique 1

An electrode plate including:

a current collector, the current collector including a substrate and a coating layer coating the substrate; and

an electrode layer disposed on the current collector, wherein

the coating layer includes conductive carbon and a first binder,

the electrode layer includes a second binder,

the first binder includes an aromatic super engineering plastic, and

the second binder includes a styrenic elastomer in which a mole fraction of a repeating unit derived from styrene is 0.18 or more.

According to such a configuration, it is possible to enhance the peel strength between the electrode layer and the current collector.

### Technique 2

The electrode plate according to Technique 1, wherein the aromatic super engineering plastic includes a polyimide. Polyimides tend to exhibit higher heat resistance. Accordingly, even under high-temperature compression of a member including the current collector, the coating layer is less likely to adhere to production equipment, such as a press machine. Consequently, productivity of electrochemical devices is enhanced.

### Technique 3

The electrode plate according to Technique 1 or 2, wherein the substrate includes aluminum or an aluminum alloy. According to such a configuration, it is possible to not only enhance the peel strength between the electrode layer and the current collector but also enhance the gravimetric energy density of electrochemical devices.

### Technique 4

The electrode plate according to any one of Techniques 1 to 3, wherein the electrode layer further includes a solid electrolyte. The electrode plate of the present disclosure is suitable for electrochemical devices, particularly batteries, in which an electrode layer includes a solid electrolyte.

### Technique 5

The electrode plate according to Technique 4, wherein the solid electrolyte includes a sulfide solid electrolyte. Sulfide solid electrolytes have more excellent ionic conductivity and formability, and accordingly are particularly suitable as the solid electrolyte of the electrode layer.

### Technique 6

A battery including:

a positive electrode;

a negative electrode; and

an electrolyte layer positioned between the positive electrode and the negative electrode, wherein

at least one selected from the group consisting of the positive electrode and the negative electrode is the electrode plate according to any one of Techniques 1 to 5.

The peel strength between the electrode layer and the current collector is high, and accordingly, a battery using an electrode plate that includes an electrode layer and a current collector as above has excellent cycle characteristics.

### EXAMPLES

The details of the present disclosure are described below using examples and comparative examples. The current collector, electrode plate, and battery of the present disclosure are not limited to the following examples.

### Example 1-1

### Fabrication of Current Collector

Conductive carbon, the first binder, and a solvent were kneaded to prepare a coating composition. As the conductive carbon, carbon black and graphite were used. As the first binder, a soluble polyimide, which is an aromatic super engineering plastic, was used. Subsequently, the coating composition was applied to one surface of an aluminum alloy foil (A3003 foil, thickness: 15 μm) to form a coating film. The coating film was dried at 165° C. to form a coating layer. Furthermore, the coating composition was applied to the other surface of the aluminum alloy foil to form a coating film. The coating film was dried at 165° C. to form a coating layer. Thus, a current collector having a coating layer on both surfaces thereof was fabricated. In the current collector of Example 1-1, the coating layer had a mass per unit area of 1.3 g/m².

### Solvent

The solvent used in all the following processes was a commercially available dehydrated solvent or a solvent dehydrated by nitrogen bubbling. The moisture content of the solvent was 10 mass ppm or less.

### Preparation of Second Binder Solution

A second binder solution was prepared by adding the solvent to the second binder and dissolving or dispersing the second binder in the solvent. The concentration of the binder in the second binder solution was 5 mass % or more and 10 mass % or less.

As the solvent for the second binder solution, tetralin was used. As the styrenic elastomer constituting the second binder, a mixture was used that included a hydrogenated styrenic thermoplastic elastomer (modified SEBS, Tuftec MP10, manufactured by Asahi Kasei Corporation) and a hydrogenated block copolymer (SEBS, G1633, manufactured by KRATON CORPORATION) in a mass ratio of 1:4. “Tuftec” is a registered trademark of Asahi Kasei Corporation.

Measurement of Mole Fraction of Repeating Unit Derived from Styrene

The mole fraction of the repeating unit derived from styrene in the styrenic elastomer was determined in the following manner. First, a measurement sample containing the styrenic elastomer was subjected to proton nuclear magnetic resonance (¹H-NMR) measurement using a nuclear magnetic resonance spectrometer (AVANCE 500, manufactured by Bruker Corporation). The measurement sample was prepared by dissolving the styrenic elastomer in CDCI3. The CDCIs contained 0.05% tetramethylsilane (TMS). The ¹H-NMR measurement was performed under conditions of a resonance frequency of 500 MHz and a measurement temperature of 23° C. From the obtained NMR spectrum, the integral value of a peak derived from the styrene skeleton and the integral value of a peak derived from a skeleton other than the styrene skeleton were determined. Based on the determined integral values, the mole fraction of the repeating unit derived from styrene in the styrenic elastomer was determined.

### Measurement of Weight-Average Molecular Weight

The weight-average molecular weight (Mw) of the styrenic elastomer constituting the second binder was measured by gel permeation chromatography (GPC) using a high-performance GPC system (HLC-832-GPC, manufactured by Tosoh Corporation). The measurement sample used was prepared by dissolving the styrenic elastomer in chloroform and performing filtration using a 0.2 μm pore-size filter. The columns used were two SuperHM-H columns manufactured by Tosoh Corporation. For the GPC measurement, a differential refractometer was used. The GPC measurement was performed under conditions of a flow rate of 0.6 mL/min and a column temperature of 40° C. The standard sample used was monodisperse polystyrene (manufactured by Tosoh Corporation). Through the GPC measurement, the weight-average molecular weight (Mw) of the styrenic elastomer was determined.

### Fabrication of Electrode Plate

In an argon glove box with a dew point of −60° C. or less, tetralin and the second binder solution were added to a Li₂S—P₂S₅-based glass-ceramic (hereinafter referred to as “LPS”). These materials were mixed in a mass ratio of LPS: second binder=100:3, and the solids concentration (NV) was adjusted to 45.0. Subsequently, the resulting liquid mixture was subjected to high-shear dispersing and kneading using a homogenizer (HG-200, manufactured by AS ONE Corporation) and a generator (K-20S, manufactured by AS ONE Corporation) to prepare a slurry. Subsequently, the slurry was applied onto the coating layer of the current collector, and the resulting coating film was dried at 100° C. for 1 hour in a vacuum atmosphere to fabricate the electrode plate of Example 1-1.

### Example 1-2

The electrode plate of Example 1-2 was fabricated in the same manner as in

Example 1-1, except that the styrenic elastomer used to constitute the second binder was a solution polymerized styrene-butadiene rubber (oil-extended modified SBR, Tufdene E680, containing a process oil with M_{w}=approximately 800, manufactured by Asahi Kasei Corporation) and that the solids concentration (NV) of the slurry was adjusted to 45.5. “Tufdene” is a registered trademark of Asahi Kasei Corporation.

### Examples 1-3

The electrode plate of Example 1-3 was fabricated in the same manner as in Example 1-2, except that the styrenic elastomer used to constitute the second binder was a solution polymerized styrene-butadiene rubber (oil-extended modified SBR, Tufdene F3440, containing a process oil with M_{w}=approximately 600, manufactured by Asahi Kasei Corporation).

### Examples 1-4

The electrode plate of Example 1-4 was fabricated in the same manner as in Example 1-2, except that the styrenic elastomer used to constitute the second binder was a solution polymerized styrene-butadiene rubber (oil-extended modified SBR, Tufdene F3520, containing a process oil with M_{w}=approximately 600, manufactured by Asahi Kasei Corporation).

### Examples 1-5

The electrode plate of Example 1-5 was fabricated in the same manner as in Example 1-1, except that the styrenic elastomer used to constitute the second binder was a solution polymerized styrene-butadiene rubber (oil-extended modified SBR, Tufdene XF354, containing a process oil with M_{w}=approximately 500, manufactured by Asahi Kasei Corporation) and that the solids concentration (NV) of the slurry was adjusted to 43.0.

### Comparative Example 1-1

The electrode plate of Comparative Example 1-1 was fabricated in the same manner as in Example 1-1, except that the first binder used was polyvinylidene fluoride. In the current collector of Comparative Example 1-1, the coating weight of the material constituting the coating layer was 0.94 g/m².

### Comparative Example 1-2

The electrode plate of Comparative Example 1-2 was fabricated in the same manner as in Example 1-2, except that the first binder used was polyvinylidene fluoride.

### Comparative Example 1-3

The electrode plate of Comparative Example 1-3 was fabricated in the same manner as in Example 1-3, except that the first binder used was polyvinylidene fluoride.

### Comparative Example 1-4

The electrode plate of Comparative Example 1-4 was fabricated in the same manner as in Example 1-4, except that the first binder used was polyvinylidene fluoride.

### Comparative example 1-5

The electrode plate of Comparative Example 1-5 was fabricated in the same manner as in Example 1-5, except that the first binder used was polyvinylidene fluoride.

### Comparative Example 1-6

The electrode plate of Comparative Example 1-6 was fabricated in the same manner as in Example 1-1, except that the styrenic elastomer used to constitute the second binder was a solution polymerized styrene-butadiene rubber (modified SBR, Asaprene Y031, manufactured by Asahi Kasei Corporation) and that the solids concentration (NV) of the slurry was adjusted to 47.0. “Asaprene” is a registered trademark of Asahi Kasei Corporation.

### Comparative Example 1-7

The electrode plate of Comparative Example 1-7 was fabricated in the same manner as in Comparative Example 1-6, except that the first binder used was polyvinylidene fluoride. <Comparative Example 1-8

The electrode plate of Comparative Example 1-8 was fabricated in the same manner as in Example 1-1, except that the styrenic elastomer used to constitute the second binder was a solution polymerized styrene-butadiene rubber (modified SBR, Asaprene XB120, manufactured by Asahi Kasei Corporation) and that the solids concentration (NV) of the slurry was adjusted to 43.0.

### Comparative Example 1-9

The electrode plate of Comparative Example 1-9 was fabricated in the same manner as in Comparative Example 1-8, except that the first binder used was polyvinylidene fluoride.

### Peel Test

The peel strength of the electrode plates of the examples and comparative examples was measured by the previously described method. The results are shown in Table 1. The measurement of peel strength was performed three times for each electrode plate. “Peel strength” shown in Table 1 represents the average of the values obtained from the three measurements.

TABLE 1

| | | Second binder of electrode layer | | | |
|---|---|---|---|---|---|
| | | | Mole fraction | Weight- | |
| | First binder | | of repeating | average | Peel |
| | of current | Polymer | unit derived | molecular | strength |
| | collector | type | from styrene | weight (Mw) | (N/m) |
| Example 1-1 | Polyimide | Mixture of | 0.19 | 313,000 | 21 |
| | | modified | | | |
| | | SEBS and | | | |
| | | SEBS | | | |
| Example 1-2 | Polyimide | Oil-extended | 0.24 | 878,000 | 18 |
| | | modified SBR | | | |
| Example 1-3 | Polyimide | Oil-extended | 0.24 | 770,000 | 12 |
| | | modified SBR | | | |
| Example 1-4 | Polyimide | Oil-extended | 0.24 | 652,000 | 12 |
| | | modified SBR | | | |
| Example 1-5 | Polyimide | Oil-extended | 0.24 | 777,000 | 14 |
| | | modified SBR | | | |
| Comparative | Polyvinylidene | Mixture of | 0.19 | 313,000 | 4.2 |
| Example 1-1 | fluoride | modified | | | |
| | | SEBS and | | | |
| | | SEBS | | | |
| Comparative | Polyvinylidene | Oil-extended | 0.24 | 878,000 | 4.5 |
| Example 1-2 | fluoride | modified SBR | | | |
| Comparative | Polyvinylidene | Oil-extended | 0.24 | 770,000 | 5.8 |
| Example 1-3 | fluoride | modified SBR | | | |
| Comparative | Polyvinylidene | Oil-extended | 0.24 | 652,000 | 4.5 |
| Example 1-4 | fluoride | modified SBR | | | |
| Comparative | Polyvinylidene | Oil-extended | 0.24 | 777,000 | 4.0 |
| Example 1-5 | fluoride | modified SBR | | | |
| Comparative | Polyimide | Modified SBR | 0.16 | 379,000 | 3.1 |
| Example 1-6 | | | | | |
| Comparative | Polyvinylidene | Modified SBR | 0.16 | 379,000 | 6.2 |
| Example 1-7 | fluoride | | | | |
| Comparative | Polyimide | Modified SBR | 0.09 | 566,000 | 0.66 |
| Example 1-8 | | | | | |
| Comparative | Polyvinylidene | Modified SBR | 0.09 | 566,000 | 0.82 |
| Example 1-9 | fluoride | | | | |

In Comparative Examples 1-1 to 1-5, the mole fraction of the repeating unit derived from styrene in the second binder of the electrode layer was 0.19 or 0.24. However, since the first binder of the coating layer of the current collector was polyvinylidene fluoride, it is considered that the interaction between the current collector and the electrode layer was insufficient. Consequently, the peel strength of the electrode plates of Comparative Examples 1-1 to 1-5 was low.

In Comparative Examples 1-6 and 1-8, the first binder of the current collector was a polyimide, which is an aromatic super engineering plastic. However, the mole fraction of the repeating unit derived from styrene in the second binder of the electrode layer was low, at 0.16 or 0.09. Accordingly, it is considered that the interaction between the current collector and the electrode layer was insufficient. Consequently, the peel strength of the electrode plates of Comparative Examples 1-6 and 1-8 was low.

In Comparative Examples 1-7 and 1-9, the first binder of the current collector was polyvinylidene fluoride, and the mole fraction of the repeating unit derived from styrene in the second binder of the electrode layer was also low. Consequently, the peel strength of the electrode plates of Comparative Examples 1-7 and 1-9 was low.

From the results shown in Table 1, it is understood that the type of the first binder in the coating layer of the current collector and the mole fraction of the repeating unit derived from styrene in the second binder of the electrode layer correlate with the peel strength. In the electrode plates of Examples 1-1 to 1-4 in which the first binder used was an aromatic super engineering plastic and the second binder used was a styrenic elastomer with a mole fraction of the repeating unit derived from styrene of 0.18 or more, the peel strength between the electrode layer and the current collector exhibited high values.

### Example 2-1

### Fabrication of Electrode Plate

In an argon glove box with a dew point of −60° C. or less, 250 g of LTO was weighed and mixed with 136 g of tetralin and 15.0 g of a dispersant solution containing a dispersant at a concentration of 5 mass % to prepare a liquid mixture. As the dispersant, 1-hydroxyethyl-2-alkenylimidazoline (DISPERBYK-109, manufactured by BYK Corporation) was used. As the solvent for the dispersant solution, tetralin was used. This liquid mixture was subjected to dispersing and kneading using a benchtop digital ultrasonic homogenizer (SONIFIER SFX550, manufactured by Branson Ultrasonics Corporation). Then, 43.4 g of a second binder solution containing the second binder at a concentration of 5 mass %, 2.75 g of vapor-grown carbon fiber (VGCF-H, manufactured by Showa Denko K.K.), and 84.0 g of LPS were added to the liquid mixture, and dispersing and kneading were performed to prepare a slurry. As the second binder, a mixture was used that included a hydrogenated styrenic thermoplastic elastomer (modified SEBS, Tuftec MP10, manufactured by Asahi Kasei Corporation) and a hydrogenated block copolymer (SEBS, G1633, manufactured by KRATON CORPORATION) in a mass ratio of 1:1. As the solvent for the second binder solution, tetralin was used. Subsequently, the slurry was applied onto the current collector of Example 1-1, and the resulting coating film was dried at 100° C. for 1 hour in a vacuum atmosphere to fabricate the electrode plate of Example 2-1.

### Comparative Example 2-1

The electrode plate of Comparative Example 2-1 was fabricated in the same manner as in Example 2-1, except that the second binder used was a solution polymerized styrene-butadiene rubber (modified SBR, Asaprene Y031, manufactured by Asahi Kasei Corporation).

### Peel Test

The peel strength of the electrode plates of Example 2-1 and Comparative Example 2-1 was measured by the previously described method. The results are shown in Table 2. The measurement of peel strength was performed three times for each electrode plate. “Peel strength” shown in Table 2 represents the average of the values obtained from the three measurements.

TABLE 2

| | | Second binder of electrode layer | | | | |
|---|---|---|---|---|---|---|
| | | | Mole | Weight- | | |
| | First | | fraction | average | Active | |
| | binder | | of repeating | molecular | material of | Peel |
| | of current | Polymer | unit derived | weight | electrode | strength |
| | collector | type | from styrene | (Mw) | layer | (N/m) |
| Example 2-1 | Polyimide | Mixture of | 0.19 | 231,000 | LTO | 0.51 |
| | | modified SEBS | | | | |
| | | and SEBS | | | | |
| Comparative | Polyimide | Modified SBR | 0.16 | 379,000 | LTO | 0.29 |
| Example 2-1 | | | | | | |

The results shown in Table 2 indicate that even when LTO was used as the active material of the electrode layer, in the electrode plate of Example 2-1, in which an aromatic super engineering plastic was used as the first binder and a styrenic elastomer in which the mole fraction of the repeating unit derived from styrene was 0.18 or more was used as the second binder, the peel strength between the electrode layer and the current collector exhibited a high value.

### INDUSTRIAL APPLICABILITY

The electrode plate of the present disclosure can be used in electrochemical devices such as batteries and capacitors.

What is claimed is:

1. An electrode comprising:
a current collector, the current collector comprising a substrate and a coating layer coating the substrate; and
an electrode layer disposed on the current collector, wherein
the coating layer comprises conductive carbon and a first binder,
the electrode layer comprises a second binder,
the first binder comprises an aromatic super engineering plastic, and
the second binder comprises a styrenic elastomer in which a mole fraction of a repeating unit derived from styrene is 0.18 or more.

2. The electrode according to claim 1, wherein
the aromatic super engineering plastic comprises a polyimide.

3. The electrode according to claim 1, wherein
the substrate comprises aluminum or an aluminum alloy.

4. The electrode according to claim 1, wherein
the electrode layer further comprises a solid electrolyte.

5. The electrode according to claim 4, wherein
the solid electrolyte comprises a sulfide solid electrolyte.

6. A battery comprising:
a positive electrode:
a negative electrode: and
an electrolyte layer positioned between the positive electrode and the negative electrode, wherein
at least one selected from the group consisting of the positive electrode and the negative electrode is the electrode according to claim 1.
